(19) United States
(12) Patent Application Publication
(10) Pub. No.: US 2007/0262033 A1
(43) Pub. Date: Nov. 15, 2007

(54) Method and apparatus to enhance separation performance of a lean and low mean size dispersed phase from a continuous phase

(75) Inventors: Shaya Movafaghian, Houston, TX (US); James C.T. Chen, Houston, TX (US)

Correspondence Address: CAMERON INTERNATIONAL CORPORATION, P.O. BOX 1212, HOUSTON, TX, 77251-1212, US

(73) Assignee: Petreco International Inc.

(21) Appl. No.: 11/434,596

(22) Filed: May 15, 2006

(51) Int. Cl. B01D 17/038

(52) U.S. Cl. 210/788; 210/512.2; 210/DIG. 5

(57) ABSTRACT

Two hydrocyclones used in series enhances the removal of a dispersed phase from a continuous phase by cyclonic action. The first hydrocyclone has no overflow outlet and serves to coalesce the droplets or particles of the disperse phase together thereby increasing contaminant size distribution. The second hydrocyclone functions as a separator operating at higher removal efficiency. The method and apparatus are useful to clarify produced water from hydrocarbon recovery operations.

### BACKGROUND OF THE INVENTION

The present invention relates to methods and apparatus for separating a liquid/liquid continuous mixture, and more particularly relates, in one embodiment, to methods and apparatus for separating or dividing a liquid dispersed phase from a liquid continuous phase of a fluid mixture.

The overall construction and manner of operation of hydrocyclones is well known. A typical hydrocyclone includes an elongated body surrounding a tapered separation chamber of circular cross-section, the separation chamber decreasing in cross-sectional size from a large overflow and input end to a narrow underflow end. An overflow or reject outlet for the lighter fraction is provided at the wider end of the conical chamber while the heavier underflow or accept fraction of the suspension exits through an axially arranged underflow outlet at the opposite end of the conical chamber. (It will be appreciated that the terms “reject” and ‘accept” are relative and depend upon the nature and value of the lighter and the heavier fractions.) Liquids and suspended particles are introduced into the chamber via one or more tangentially directed inlets, which inlets create a fluid vortex in the separation chamber. The centrifugal forces created by this vortex throw denser fluids and particles in suspension outwardly toward the wall of the conical separation chamber, thus giving a concentration of denser fluids and particles adjacent thereto, while the less dense fluids are brought toward the center of the chamber and are carried along by an inwardly-located helical stream created by differential forces. The lighter fractions are thus carried outwardly through the overflow outlet. The heavier particles and/or fluids continue to spiral along the interior wall of the hydrocyclone and exit the hydrocyclone via the underflow outlet.

The fluid velocities within a hydrocyclone are high enough that the dynamic forces produced therein are sufficiently high to overcome the effect of any gravitational forces on the performance of the device. Hydrocyclones may, therefore, be arranged in various physical orientations without affecting performance. Hydrocyclones, especially those for petroleum fluid processing, are commonly arranged in large banks of several dozen or even several hundred hydrocyclones with suitable intake, overflow and underflow assemblies arranged for communication with the intake, overflow and underflow openings, respectively, of the hydrocyclones.

Hydrocyclones are used both for the separation of liquids from solids in a liquid/solid mixture (“liquid/solid hydrocyclones”) as well as for the separation of liquids from other liquids (“liquid/liquid hydrocyclones”). Different constructions are used for each of these hydrocyclone devices. Generally, the liquid/liquid type of hydrocyclone is longer in the axial direction than a solid/liquid hydrocyclone and is thinner as well. As a result of these structural differences, it cannot be assumed that the design and structure of a liquid/liquid hydrocyclone usefully translates to a liquid/solid hydrocyclone and vice versa.

In the recovery of hydrocarbons from subterranean formations, it is common that the fluids produced are mixtures of aqueous fluids, typically water, and non-aqueous fluids, typically crude oil. These fluid mixtures are often in the form of tight emulsions that are difficult to separate. In general, oil-in-water emulsions (o/w) and water-in-oil emulsions (w/o) are separated by physical processes, chemical processes, such as through the use of demulsifiers and other additives, or combinations of the two. Hydrocyclones are known to be a useful physical method of separating oil phase fluids from aqueous phase fluids, along with other apparatus including, but not necessarily limited to, settling tanks, centrifuges, membranes, and the like. Additionally, electrostatic separators employ electrical fields and the differences in surface conductivity of the materials to be separated to aid in these separations.

“Produced water” is the term used to refer to streams generated by the recovery of hydrocarbons from subterranean formations that are primarily water, but may contain significant amounts of non-aqueous contaminants dispersed therein. Typically, produced water results from an initial separation of oil and water, and accounts for a majority of the waste derived from the production of crude oil. After a primary process of separation from the oil, the produced water still contains drops or particles of oil in emulsion in concentrations as high as 2000 mg/l, and thus it must be further treated before it may be properly discharged to the environment. Every country has set limits for the concentration of oil dispersed in the water for offshore wells and for near-shore fields. Even if the produced water is returned to the field, it is advisable to remove as much of the oil and suspended solids (e.g., sand, rock fragments, and the like) as possible in order to minimize the risk of clogging the field.

It would be desirable if methods and apparatus were devised that could simultaneously remove oil and other non-aqueous species from produced water and contaminated water with greater efficiency than at present.

### BRIEF SUMMARY OF THE INVENTION

In carrying out these and other objects of the invention, there is provided, in one non-restrictive form, an exemplary apparatus for separating a dispersed liquid phase from a continuous liquid phase within a fluid mixture. The apparatus has one or more coalescers that each includes a first separation chamber having a first inlet portion at one end of the separation chamber and a first outer wall portion throughout the first separation chamber. The coalescers also each incorporates one or more first inlets for introducing the fluid mixture into the first inlet portion of the first separation chamber to generate a swirling motion of the fluid mixture and to at least partially coalesce the dispersed liquid phase. The coalescers additionally each contains at least one outlet at the other end of the first separation chamber for discharging therefrom the fluid mixture that contains the at least partially coalesced dispersed liquid phase. The apparatus also includes one or more separator hydrocyclones each containing a second separation chamber having a second inlet portion at one end of the second separation chamber and a second outer wall portion throughout the first separation chamber. Each separator hydrocyclone also contains at least one second inlet for introducing the fluid mixture comprising the at least partially coalesced dispersed liquid phase into the second inlet portion of the second separation chamber to generate a swirling motion of the fluid mixture and to substantially separate the at least partially coalesced dispersed liquid phase from the continuous liquid phase. Each separator hydrocyclone also includes at least one overflow outlet on the second separation chamber for discharging therefrom a relatively less dense, coalesced liquid phase of the fluid mixture, and at least one underflow outlet on the other end of the second separation chamber from the at least one overflow outlet for discharging a relatively more dense liquid phase of the fluid mixture. Further, an exemplary apparatus includes at least one fluid communication between the at least one outlet of the one or more coalescers and the at least one second inlet of the one or more separator hydrocyclones.

As another example and in another non-limiting embodiment, a method for separating a dispersed liquid phase from a continuous liquid phase within a fluid mixture that involves introducing the fluid mixture into at least one coalescer. The fluid mixture is swirled within the coalescer to at least partially coalesce the dispersed liquid phase. The fluid mixture comprising an at least partially coalesced dispersed liquid phase is discharged to at least one separator hydrocyclone. The fluid mixture is swirled within the separator hydrocyclone to substantially separate the at least partially coalesced dispersed liquid phase. A relatively less dense, coalesced liquid phase of the fluid mixture is discharged through an overflow outlet. A relatively more dense liquid phase of the fluid mixture is discharged through an underflow outlet.

In another non-restrictive example, an apparatus for separating a dispersed liquid phase from a continuous liquid phase within a fluid mixture includes a first elongate hollow member with a first inlet portion and a first outlet portion. The first inlet portion has a greater cross-section diameter, taken transverse to a longitudinal axis of the first elongate member, than the first outlet portion of the member. The first outlet portion is configured to effuse substantially all fluid flow egressing from the first elongate hollow member and received at the first inlet portion. The apparatus also includes a second elongate member with a second inlet portion and a second outlet portion. The second inlet portion has a greater cross-section diameter, taken transverse to a longitudinal axis of the second elongate member, than the second outlet portion of the second elongate member. The second elongate member has a third outlet portion. The first outlet portion is in fluid communication with the second inlet portion; and the second inlet portion is upstream of the second and third outlet portions.

In still another non-limiting embodiment a method for separating a dispersed liquid phase from a continuous liquid phase within a fluid mixture, involves routing a flow of fluid into a first inlet portion of a first elongate hollow member and at least partially coalescing the flow by generating a vortex along an inner wall of the elongate hollow member. The flow of fluid egresses only from a first outlet portion located toward one end of the first elongate hollow member. The flow of fluid from the first outlet portion of the first elongate hollow member is routed to a second inlet portion of a second elongate hollow member. A relatively less dense, coalesced liquid phase of the flow of fluid is discharged through a second outlet of the second elongate hollow member and located toward one side of the inlet portion of the second elongate hollow member. A relatively more dense liquid phase of the flow of fluid is discharged through a third outlet portion of the second elongate hollow member and located on an opposite side from the second inlet portion of the second elongate hollow member and the second outlet portion of the second elongate hollow member.

### BRIEF DESCRIPTION OF THE SEVERAL VIEWS OF THE DRAWING

FIG. 1 is a schematic cross-sectional illustration of one non-limiting embodiment of the apparatus contained in a single vessel for separating a dispersed liquid phase mixed with a continuous phase as described herein;

FIG. 2 is a detailed, schematic, cross-sectional illustration of one embodiment of the outlet from the coalescer of FIG. 1;

FIG. 3 is an schematic, cross-sectional illustration of an alternate embodiment of the outlet from the coalescer of FIG. 1 as well as the circulation within the coalescer;

FIG. 4 is a schematic cross-sectional illustration of another non-restrictive embodiment of the apparatus contained in a single vessel for separating a dispersed liquid phase mixed with a continuous phase as described herein;

FIG. 5 is a schematic cross-sectional illustration of an alternate non-limiting embodiment of the system for separating a dispersed liquid phase mixed with a continuous phase as described herein, shown in two separate vessels;

FIG. 6 is a plot of a hypothetical series of curves of the separation probability as a function of droplet size; and

FIG. 7 is a plot of a hypothetical series of curves showing the distribution as a function of size at the outlet of the separator hydrocyclone.

It will be appreciated that the Figures are schematic illustrations that are not to scale or proportion, and, as such, some of the important parts of the invention may be exaggerated for illustration.

### DETAILED DESCRIPTION OF THE INVENTION

Non-limiting exemplary methods and apparatus described herein enhance the removal of a dispersed phase from a continuous phase intermixed therewith by means of cyclonic action of two or more hydrocyclones in series. The first hydrocyclone or batch of first hydrocyclones (also called coalescers herein) increase the size distribution of the dispersed phase, while subsequently the second or separator hydrocyclone or batch of second or separator hydrocyclones separates the coalesced dispersed phase from the continuous phase at a higher removal efficiency. In one non-limiting embodiment, the dispersed phase may be a contaminant, such as oil in a continuous phase of produced water. A non-limiting application for the apparatus and methods herein is to separate the components of a wellbore fluid involved in hydrocarbon recovery, including, but not necessarily limited to produced water from a subterranean formation. In a non-restrictive instance, produced water on an offshore platform that has the contaminants sufficiently removed therefrom may be properly disposed of in the sea.

In more detail, one non-restrictive example includes utilization of this method to enhance removal efficiency of hydrocyclones in a produced water treatment, where existing hydrocyclones or degassers or flotation units do not meet oil and grease discharge requirements due to small size distribution or lean concentration of the contaminants. Indeed, the apparatus and methods described herein are expected to find particular utility in removing lean and/or low concentrations of a dispersed phase from a continuous phase dispersed therewith, and/or separating a dispersed phase from a continuous phase where the dispersed phase has a relatively low mean size distribution therein.

Although conventional hydrocyclones generally have both an underflow outlet and an overflow outlet, it will be appreciated that the first hydrocyclone or coalescer in an exemplary apparatus described herein (or each of the first hydrocyclones or coalescers in the case of a batch thereof) does not have a conventional overflow outlet

Each hydrocyclone or batch of hydrocyclones may be contained within a single enclosure or vessel or may be housed within separate enclosures or vessels. For instance, in one non-limiting embodiment, the coalescers may be housed or contained in one vessel while the separators are contained or housed in a second vessel. In general, in another optional, alternative embodiment, the coalescers and the separators have a conical section or profile followed by a tubular tail section which may or may not be tapered on the inside.

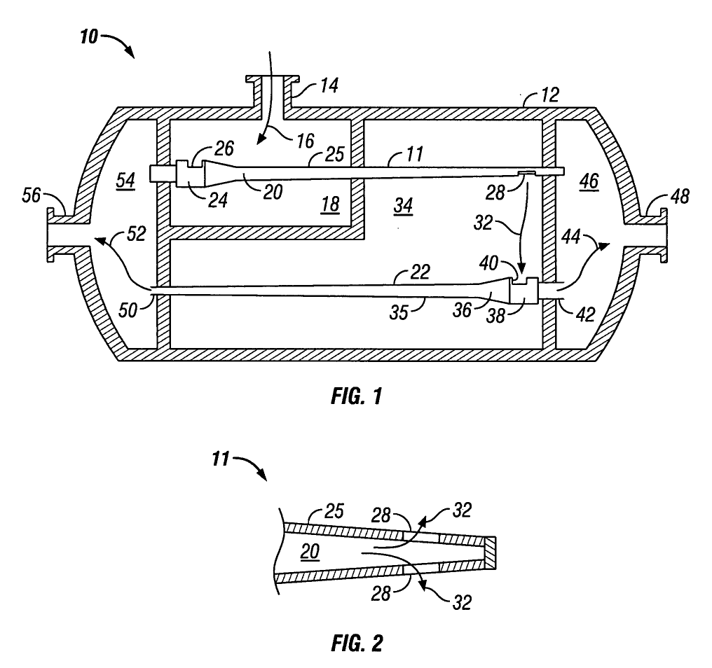

Shown in more detail with respect to FIG. 1 is an exemplary system or apparatus 10 for separating a dispersed liquid phase combined with a continuous liquid phase in a fluid mixture, where the apparatus includes a pressure vessel 12 or other container or enclosure, at least one first coalescer or first elongate hollow member 11 and at least one separator hydrocyclone or second elongate hollow member 22. In one non-limiting embodiment herein, the first and second elongate hollow members 11 and 22 have generally tapered profiles as seen in FIGS. 1, 3, 4 and 5, and/or conical profiles. Vessel 12 has an inlet 14 for accepting the fluid mixture 16 into inlet chamber 18 of vessel 12. This permits fluid mixture 16 to enter first separation chamber 20 of first coalescer 11 via first inlet portion 24 at one end (larger left end in FIG. 1) of the separation chamber 20, where the separation chamber 20 is defined by a first outer wall portion 25 throughout the first separation chamber 20.

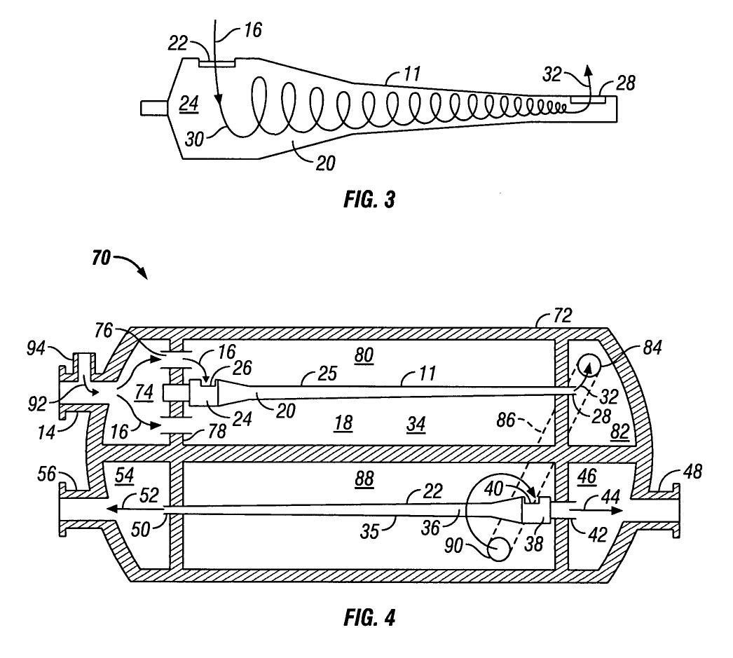

In the known operation of hydrocyclones, the fluid velocity of fluid mixture 16 introduced into first inlet portion 24 through first inlet 26 generates a swirling motion or vortex in the first separation chamber 20 that at least partially coalesces the dispersed liquid phase (e.g., contaminant droplets, oil, etc.). In one non-restrictive embodiment of the method, the vortex is generated along the inner wall (opposite side of outer wall 25) of the first elongate hollow member 11. The vortex or swirling motion 30 is shown in more detail in the cross-section schematic illustration of FIG. 3.

As illustrated, coalescer 11 does not include an overflow outlet that might typically be found in a hydrocyclone at the larger end thereof, but does include at least one outlet or first outlet portion 28 at the other end thereof. In one non-limiting embodiment the first inlet portion 24 has a greater cross-section diameter, taken transverse to a longitudinal axis 29 of the first elongate member 11, than the first outlet portion 28. The vortex or swirling motion 30 discharges a fluid mixture 32 that contains an at least partially coalesced liquid phase into intermediate chamber 34 of vessel 12. It will be appreciated that there is no particular threshold or level of coalescence that may or could be specified in advance for fluid mixture 32, and that any degree or level of coalescence that improves the overall separation efficiency of the apparatus 10 is sufficient for the method and apparatus herein to be considered successful. That is, the method and apparatus herein should increase the separation efficiency as compared with a method and apparatus using only one hydrocyclone. Understood another way, first outlet portion 28 is configured to effuse substantially all fluid flow egressing from the first elongate hollow member 11 and received at the first inlet portion 24.

Partially coalesced fluid mixture 32 passes to separator hydrocyclone or second elongate hollow member 22 having a second separation chamber 36 having a second outer wall portion 35 throughout the second separation chamber 36 with a second inlet portion 38 at the larger (right) end of the second separation chamber 36. Separator hydrocyclone 22 has at least one second inlet 40 in the larger (right) end of the second separation chamber 36 for introducing the partially coalesced fluid mixture 32 into the second inlet portion 38 of the second separation chamber 36 to generate a swirling motion of the fluid mixture and to substantially separate the at least partially coalesced liquid phase, e.g., oily contaminants, from the continuous phase, e.g., water. By “substantially separate” herein is meant that at least a majority (greater than 50 volume %) of the coalesced liquid phase, which is larger than certain size (cut size) is separated, alternatively at least 80 vol. % of the coalesced liquid phase is separated, and in another non-limiting embodiment, at least 90 vol. % of the coalesced liquid phase present is separated. The cut size refers to a specific contaminant size from the size distribution of dispersed phase, which is substantially separated in accordance with operational and geometrical parameters of the hydrocyclone.

Separator hydrocyclone 22 also includes at least one overflow outlet or second outlet portion 42 for discharging a relatively less dense coalesced liquid phase 44 into overflow outlet chamber 46 of vessel 12 and through overflow outlet 48. Overflow outlet 42 may be coaxial with a vortex finder (not shown) in hydrocyclone 22 on the axis of separator hydrocyclone 22 typically found in a hydrocyclone, as is known in the art. In one non-limiting embodiment, the second inlet portion 38 has a greater cross-section diameter, taken transverse to a longitudinal axis (not shown) of the second elongate member 22, than the second outlet portion 42.

Separator hydrocyclone 22 additionally includes at least one underflow outlet or third outlet portion 50 on the other end of the second separation chamber 36 from the at least one overflow outlet 42 for discharging a relatively more dense liquid phase 52 (e.g., clarified water) of the fluid mixture. Relatively more dense liquid phase 52 enters underflow outlet chamber 54 of vessel 12, and exits vessel 12 through underflow outlet 56. In another non-restrictive version, second inlet portion 38 is upstream of the second and third outlet portions, 42 and 50, respectively, and in another non-limiting embodiment the second inlet portion 38 is physically intermediate the second and third outlet portions, 42 and 50, respectively. Further in another non-limiting embodiment, second outlet portion 42 of the second elongate hollow member 22 and located toward one side of the inlet portion 38 of the second elongate hollow member 22. Third outlet portion 50 of the second elongate hollow member 22 may be located on an opposite side from the second inlet portion 38 of the second elongate hollow member 22 and the second outlet portion 42 of the second elongate hollow member 42.

This apparatus or system has at least one fluid communication pathway between the at least one outlet 28 of the coalescer 11 and the at least one second inlet 40 of the at least one separator hydrocyclone 22. In the non-limiting embodiment of FIG. 1, this fluid communication pathway is intermediate chamber 34; however, as will be seen, other, alternate configurations may be usefully employed.

Shown in FIG. 2 is a detailed, schematic, cross-sectional illustration of one outlet 60 from the narrow end of the coalescer 11 where the fluid mixture 32 that contains an at least partially coalesced liquid phase exits through the slot shape opening or openings 28 on the body and near the end of the tail section of the coalescer 11. The openings 28 may be of any shape and variation suitable for the application and adapted for better construction of the coalescer 11.

It will be appreciated that first separation chamber 20 has a first interior diameter (not shown) and that second separation chamber 36 has a second interior diameter. While the two diameters may be identical, it will be appreciated that in most expected embodiments of the apparatus 10 the second interior diameter will be smaller than the first interior diameter. This design has the effect that the vortex or swirling motion 30 of coalescer 11 generates a first G-force and the swirling motion or vortex within the separator 22 generates a second G-force, where the second G-force is equal to or greater than the first G-force. However, it will be appreciated that in other alternate versions the second G-force may be less than the first G-force. In one non-limiting embodiment, the first G-force may be in the order of 100s, whereas the second G-force may be of the same magnitude or higher depending on the geometry of the second hydrocyclone or combination of geometry or number of batch of hydrocyclones. The G is defined herein as a unit measuring the inertial stress on a body undergoing rapid acceleration, expressed in multiples of the acceleration of one earth gravity.

Shown in FIG. 4 is another embodiment of the invention apparatus 70 where the coalescer 11 and the separator 22 are again within a single vessel 72. Similar components or elements will be given similar reference numerals as those used in FIG. 1 for clarity. In the FIG. 4 embodiment fluid mixture 16 enters vessel 72 through inlet 14, advances to inlet chamber 74 and, in turn, through openings 76 in wall 78, and progresses into coalescer chamber 80 and through inlet 26 of coalescer 11 as described above.

As established above in the discussion of FIGS. 1 and 3, the fluid velocity of fluid mixture 16 introduced into first inlet portion 24 through first inlet 26 generates a swirling motion or vortex 30 in the first separation chamber 20 that at least partially coalesces the dispersed liquid phase (e.g., contaminant droplets, oil, etc.) to give at least partially coalesced fluid mixture 32 that exits into intermediate chamber 82 and passes into opening 84 of fluid communication 86 in the FIG. 4 embodiment a pipeline or conduit (shown in dashed lines) that connects with separator chamber 88 at aperture 90.

At least partially coalesced fluid mixture 32 in separator chamber 88 enters separator 22 at inlet 40 and is separated therein as described with respect to FIG. 1, where the relatively less dense coalesced liquid phase 44 exits separator 22 at overflow outlet 42 into overflow outlet chamber 46 and is discharged at overflow outlet 48. Correspondingly, relatively more dense liquid phase 52 leaves separator 22 at underflow outlet 50 into underflow outlet chamber 54 and is discharged through underflow outlet 56.

In one optional embodiment, a chemical coalescing agent or demulsifier 92 may be introduced into the fluid mixture 16 (or at least partially coalesced fluid mixture 32) through an opening 94. In one non-limiting embodiment, the chemical coalescing agent 92 is introduced upstream of first inlet 26, but may be introduced at other locations in addition to or alternative to this one. The chemical coalescing agent 92 aids in coalescing the particles or droplets of the dispersed phase (e.g., contaminant oil) together.

In another optional embodiment, a relatively clean side stream of the dispersed phase (e.g., oil) can be introduced into the fluid mixture 16. The overall effect is expected to be the promotion of collisions in the lean (low concentration) effluent. In one non-limiting embodiment, the side stream 92 is introduced upstream of first inlet 26, but may be introduced at other locations in addition to or alternative to this one. This side stream 92 aids in coalescing the particles or droplets of the dispersed phase (e.g., contaminant oil) together by increasing the population density of the dispersed phase.

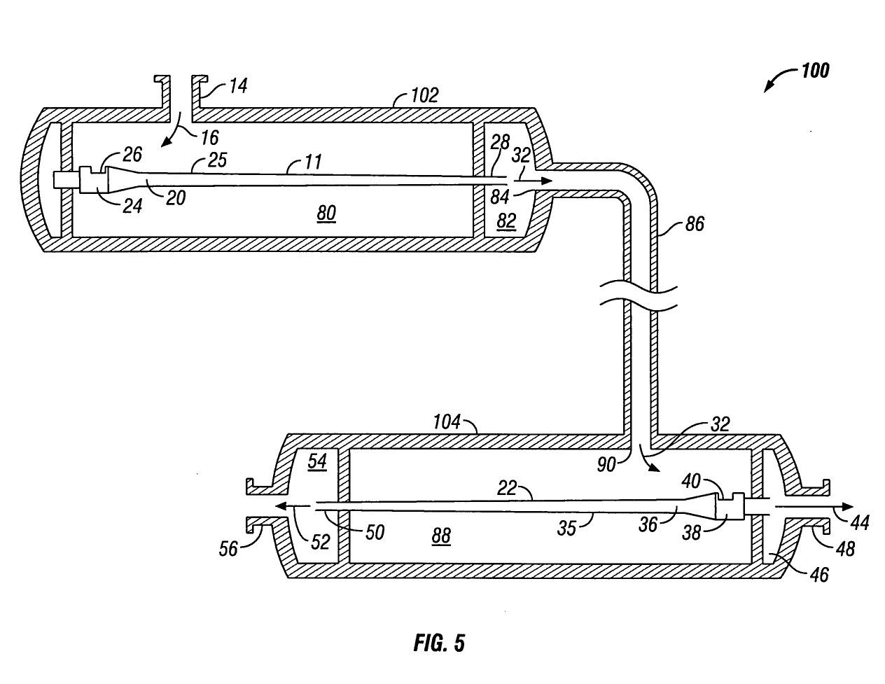

Shown in FIG. 5 is schematic cross-sectional illustration of an alternate non-limiting embodiment of a system 100 for separating a dispersed liquid phase mixed with a continuous phase as described herein where coalescer 11 is in a first vessel 102 and separator 22 is in a separate, second vessel 104. Again, like reference numerals will be used for like components or elements from the previously discussed Figures. Because the chambers 80 and 88 are in separate vessels 102 and 104, respectively, the shape and design of fluid communication (pipeline or conduit) 86 for the FIG. 5 design is different from that of the FIG. 1 or FIG. 4 design, but its function of channeling at least partially coalesced fluid mixture 32 from outlet 28 through intermediate chamber 82 and opening 84 and aperture 90 into separator chamber 88 is the same.

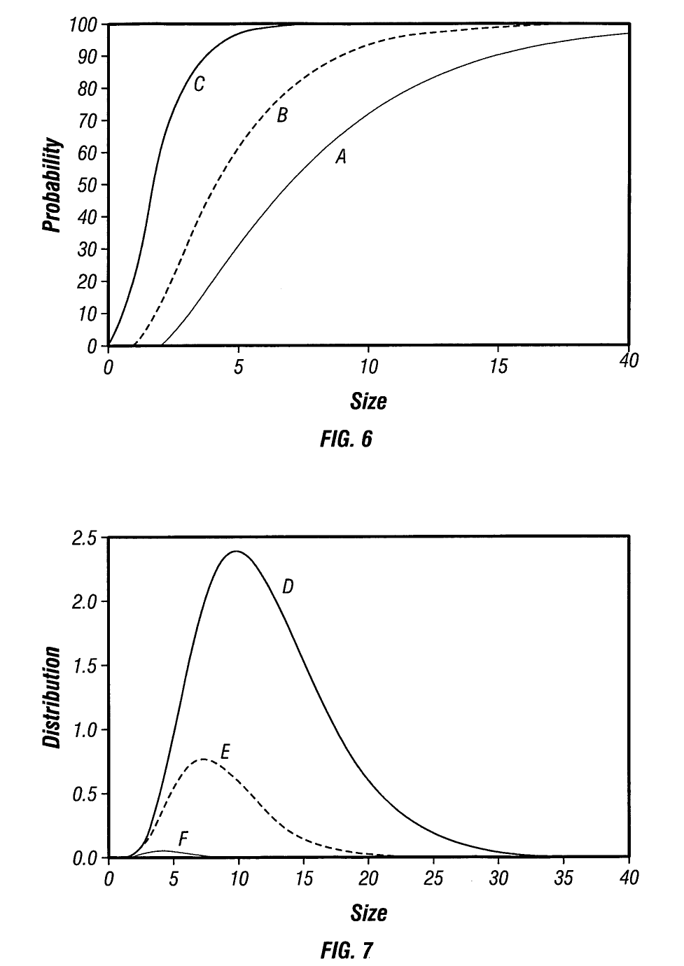

In one non-limiting example of the system or apparatus herein, FIG. 6 shows a hypothetical droplet separation probability in the separator (e.g., separator hydrocyclone 22). The increased collision probability resulting from coalescence effect of the coalescer 11 ahead of the separator 22 will lead to additional separation, which will shift the curve A to the left to form curve B. Curve B indicates higher capture probability of a given size contaminant. The same trend can also be generated if the geometry of the hydrocyclone is altered. In one non-limiting example of such alteration, curve C is indicative of a similar hydrocyclone with smaller diameter. This curve shows additional potential gain in capture pros ability realized by reducing the diameter of the hydrocyclone. Similar effects can be realized by alteration of one or multiple geometrical parameters.

FIG. 7 is a more practical demonstration of the effect shown in FIG. 6. Curve D is indicative of size distribution at the outlet of separator. The area under the curve E shows the decrease in concentration of the contaminant in the outlet compared to the area under curve D. The enhancement is attributed to the increase in droplet size distribution caused by the coalescer 11 ahead of the separator 22. Curve F shows the potential effect of reducing the geometrical parameters of either the coalescer 11 to promote size distribution or separator 22 to promote capture probability of smaller species. The resulting effect is a reduction in mean and area under curve F.

In the foregoing specification, the invention has been described with reference to specific embodiments thereof, and is expected to be effective in providing methods and apparatus for separating mixed liquid phases more efficiently. However, it will be evident that various modifications and changes can be made thereto without departing from the broader spirit or scope of the invention as set forth in the appended claims. Accordingly, the specification is to be regarded in an illustrative rather than a restrictive sense. For example, the coalescers and separators may be changed or optimized from that illustrated and described, and even though they were not specifically identified or tried in a particular apparatus, would be anticipated to be within the scope of this invention. For instance, the use of more hydrocyclones in series would be expected to find utility and be encompassed by the appended claims. Different dispersed and continuous liquid phases, and different oily matter other than those described herein may nevertheless be treated and handled in other non-restrictive embodiments of the invention.

We Claim:

1. An apparatus for separating a dispersed liquid phase from a continuous liquid phase within a fluid mixture, comprising:
a first elongate hollow member having a first inlet portion and a first outlet portion, the first inlet portion having a greater cross-section diameter, taken transverse to a longitudinal axis of the first elongate member, than the first outlet portion; wherein the first outlet portion is configured to effuse substantially all fluid flow egressing from the first elongate hollow member and received at the first inlet portion;
a second elongate hollow member having a second inlet portion and a second outlet portion, the second outlet portion having a greater cross-section diameter, taken transverse to a longitudinal axis of the second elongate member, than the second outlet portion, and further having a third outlet portion;
wherein the first outlet portion is in fluid communication with the second inlet portion; and
wherein the second inlet portion is upstream of the second and third outlet portions.

2. The apparatus as recited in claim 1, wherein the second inlet portion is physically intermediate the second and third outlet portions.

3. The apparatus of claim 1, wherein the first and second elongate hollow members have generally tapered profiles.

4. An apparatus for separating a dispersed liquid phase from a continuous liquid phase within a fluid mixture, comprising:
at least one coalescer including:
a first separation chamber having a first inlet portion at one end of the separation chamber;
at least one first inlet for introducing the fluid mixture into the first inlet portion of the first separation chamber for swirling the fluid mixture and to at least partially coalesce the dispersed liquid phase;
at least one outlet at the other end of the first separation chamber for discharging therefrom the fluid mixture comprising an at least partially coalesced dispersed liquid phase; and
at least one separator hydrocyclone including:
a second separation chamber having a second inlet portion at one end of the second separation chamber;
at least one second inlet for introducing the fluid mixture comprising the at least partially coalesced dispersed liquid phase into the second inlet portion of the second separation chamber for swirling the fluid mixture and to substantially separate the at least partially coalesced dispersed liquid phase from the continuous liquid phase;
at least one overflow outlet on the second separation chamber for discharging therefrom a relatively less dense, coalesced liquid phase of the fluid mixture; and
at least one underflow outlet on the other end of the second separation chamber from the at least one overflow outlet for discharging a relatively more dense liquid phase of the fluid mixture; and
at least one fluid communication between the at least one outlet of the at least one coalescer and the at least one second inlet of the at least one second separator hydrocyclone.

5. The apparatus of claim 4 where the coalescer lacks an overflow outlet.

6. The apparatus of claim 4 where the first separation chamber has a first interior diameter and where the second separation chamber has a second interior diameter, such that the second interior diameter is smaller than the first interior diameter.

7. The apparatus of claim 4 where the at least one coalescer and at least one second separator hydrocyclone are within a single vessel.

8. The apparatus of claim 4 where the at least one coalescer is within a first vessel and the at least one separator hydrocyclone is within a second vessel.

9. The apparatus of claim 4 further comprising an opening for introducing a chemical coalescing agent into the fluid mixture.

10. The apparatus of claim 9 where the opening is upstream of the at least one first inlet.

11. The apparatus of claim 4 where the coalescer lacks an overflow outlet and where the first separation chamber has a first interior diameter and where the second separation chamber has a second interior diameter, such that the second interior diameter is smaller than the first interior diameter.

12. A method for separating a dispersed liquid phase from a continuous liquid phase within a fluid mixture, comprising:
routing a flow of fluid into a first inlet portion of a first elongate hollow member;
at least partially coalescing the flow by generating a vortex along an inner wall of the first elongate hollow member;
egressing the flow of fluid only from a first outlet portion located toward one end of the first elongate hollow member;
routing the flow of fluid from the first outlet portion of the first elongate hollow member to a second inlet portion of a second elongate hollow member;
discharging a relatively less dense, coalesced liquid phase of the flow of fluid through a second outlet portion of the second elongate hollow member and located toward one side of the inlet portion of the second elongate hollow member; and
discharging a relatively more dense liquid phase of the flow of fluid through a third outlet portion of the second elongate hollow member and located on an opposite side from the second inlet portion of the second elongate hollow member and the second outlet portion of the second elongate hollow member.

13. The method of claim 12 where the fluid mixture is a wellbore fluid.

14. A method for separating a dispersed liquid phase from a continuous liquid phase within a fluid mixture, comprising:
introducing the fluid mixture into at least one coalescer;
swirling the fluid mixture within the coalescer to at least partially coalesce the dispersed liquid phase;
discharging the fluid mixture comprising an at least partially coalesced dispersed liquid phase to at least one separator hydrocyclone;
swirling the fluid mixture within the separator hydrocyclone to substantially separate the at least partially coalesced dispersed liquid phase;
discharging a relatively less dense, coalesced liquid phase of the fluid mixture through an overflow outlet of the separator hydrocyclone; and
discharging a relatively more dense liquid phase of the fluid mixture through an underflow outlet of the separator hydrocyclone.

15. The method of claim 14 where the coalescer lacks an overflow outlet.

16. The method of claim 14 where the at least one coalescer and the at least one separator hydrocyclone are within a single vessel.

17. The method of claim 14 where the at least one coalescer is within a first vessel and the at least one separator hydrocyclone is within a second vessel.

18. The method of claim 14 further comprising introducing a chemical coalescing agent into the fluid mixture.

19. The method of claim 18 where the chemical coalescing agent is injected into the fluid mixture upstream of the coalescer.

20. The method of claim 14 where the fluid mixture is a wellbore fluid.

21. The method of claim 14 where the coalescer further comprises:
a first separation chamber having a first inlet portion at one end of the separation chamber;
at least one first inlet for receiving the fluid mixture into the first inlet portion of the first separation chamber;
at least one outlet at the other end of the first separation chamber; and
no overflow outlet;
and where the separator hydrocyclone comprises:
a second separation chamber having a second inlet portion at one end of the second separation chamber;
at least one second inlet for receiving the fluid mixture into the second inlet portion of the second separation chamber;
at least one overflow outlet on the second separation chamber; and
at least one underflow outlet on the other end of the second separation chamber from the at least one overflow outlet.

22. The method of claim 21 where the first separation chamber has a first interior diameter and where the second separation chamber has a second interior diameter, such that the second interior diameter is smaller than the first interior diameter.

23. The method of claim 21 where the at least one coalescer is within a first vessel and the at least one separator hydrocyclone is within a second vessel.
